(19) United States
(12) Patent Application Publication
(10) Pub. No.: US 2018/0037011 A1
(43) Pub. Date: Feb. 8, 2018

(54) Reinforcing Board for Decorative Thin Faced Panel

(71) Applicant: Stone Fabricators, LLC, Middletown, CT (US)

(72) Inventors: Gennaro Martorelli, Meriden, CT (US); Juan Guerrera, Meriden, CT (US)

(21) Appl. No.: 15/671,473

(22) Filed: Aug. 8, 2017

Related U.S. Application Data
(60) Provisional application No. 62/372,066, filed on Aug. 8, 2016.

(51) Int. Cl. B32B 21/14; B32B 3/12; B29C 44/58; B29C 44/34; B32B 5/18; B29C 44/02

(52) U.S. Cl. CPC B32B 21/14; B32B 5/18; B29C 44/02; B29C 44/58; B29C 44/3415; B32B 3/12; B29L 2031/722

(57) ABSTRACT

A method of producing a composite panel is described. The method includes the steps of (a) placing a veneer in a mold, (b) dispensing an expandable foam onto the veneer in the mold; (c) placing a cover over the expandable foam in the mold, wherein the cover is placed over the expandable foam prior to the foam expanding; and (d) allowing the foam to expand in the mold. The expansion of the foam is restricted by the closed mold to produce a composite panel containing expanded foam layer having a density of at least 6 pounds/ft³.

### FIELD OF THE INVENTION

The present invention relates generally to a method of producing an impact resistant decorative light weight structural veneer composite panel.

### BACKGROUND OF THE INVENTION

Plastic laminate countertops have been used in construction since at least the late 1930's. Even after such time, the industry continues to attach the laminate to a heavy composite wood substrate by means of an adhesive. To date, no economically viable, lightweight alternative structural reinforcing substrate has been developed for this or related applications.

In other applications, including boatbuilding and elevator construction, in which lightweight components are generally desirable, honeycomb panels have been laminated to decorative veneers. However, when a mitered apron is required, such as when it is desirable to create complex shapes comprising one or more joints, with the laminate materials, blocking must be installed at the joint prior to fabrication. This additional step adds both labor and time to the manufacturing process.

In more recent years, ceramic manufacturers have begun to produce thin porcelain slabs, including slabs as thin as about 3 mm. The industry has gravitated towards attaching these porcelain slabs or sheets by means of various adhesives, to a variety of substrates including wood, cement boards, honeycomb panels with resin skins, and low density foam sheets with fabric skins, among others.

However, as discussed above, honeycomb panels present problems with gluing or adhering mitered edges because of the voids inherent in the material. Foam sheets do not provide for adequate support for overhangs and lack adequate density, which can lead to a brittle surface that is easily cracked upon impact. Cement boards do not provide a lightweight solution unless they are thin, which in turn requires the use of an additional structural reinforcing support. The cement board can also take on water when cutting with water cooled blades, and expand, causing the veneer panel to curl, and making it difficult to miter the edge. In all of these instances, the need to attach the thin veneer to a substrate using an adhesive causes a significant bottleneck in the manufacturing process.

The present invention was developed to overcome the shortcomings of existing methods and procedures in the fabrication of architectural veneer panels.

### SUMMARY OF THE INVENTION

It is an object of the present invention to provide a method of making a composite panel.

It is another object of the present invention to provide a method of making a composite panel comprising a veneer.

It is still another object of the present invention to provide a method of making a composite panel that does not require the use of an adhesive.

To that end, in one embodiment, the present invention relates generally to a method of producing a composite panel, the method comprising the steps of:
a) placing a veneer in a mold, said veneer having a face side and a backside, wherein the veneer is placed face side down;
b) dispensing an expandable foam onto the backside of the veneer in the mold; and
c) placing a cover over the expandable foam in the mold, wherein the cover is placed over the expandable foam prior to the foam expanding; and
d) allowing the foam to expand in the mold;
wherein expansion of the foam in the closed mold is restricted.

In another embodiment, the present invention relates generally to an impact resistant, decorative, lightweight structural veneer composite panel comprising:

a) a decorative veneer sheet;

b) an expanded foam layer, wherein the expanded foam layer has a density of at least about 6 pounds/ft³;

and

c) optionally, a reinforcing membrane,

wherein an adhesive is not used to join the decorative veneer sheet with the expanded foam layer.

### BRIEF DESCRIPTION OF THE FIGURES

FIG. 1 depicts a view of a composite panel in accordance with one aspect of the present invention, in which a flexible membrane is disposed on the expanded foam layer.

FIG. 2 depicts a view of a composite panel in accordance with one aspect of the present invention, in which a woven mesh is disposed on the expanded foam layer.

FIG. 3 depicts a view of a composite panel in accordance with one aspect of the present invention, in which a woven mesh is disposed within the expanded foam layer.

FIG. 4 depicts a view of a composite panel in accordance with one aspect of the present invention, in which a continuous filament mat is disposed on the expanded foam layer.

FIG. 5 depicts a view of a composite panel in accordance with one aspect of the present invention, in which a rigid membrane is disposed on the expanded foam layer.

FIG. 6 depicts a view of a composite panel in accordance with one aspect of the present invention, in which chopped fibers are dispersed within the expanded foam layer.

FIG. 7 depicts a view of a composite panel in accordance with one aspect of the present invention, in which rods are disposed within the expanded foam layer.

### DETAILED DESCRIPTION OF THE PREFERRED EMBODIMENTS

The present invention relates generally to a method of producing an impact resistant decorative light weight structural veneer composite panel by casting an internally or externally reinforced foam material directly to the veneer sheet or panel.

As used herein, the term “ about” refers to a measurable value such as a parameter, an amount, a temporal duration, and the like and is meant to include variations of +1-15% or less, preferably variations of +1-10% or less, more preferably variations of +/−5% or less, even more preferably variations of +/−1% or less, and still more preferably variations of +1-0.1% or less of and from the particularly recited value, in so far as such variations are appropriate to perform in the invention described herein. Furthermore, it is also to be understood that the value to which the modifier “about” refers is itself specifically disclosed herein.

As used herein, the term “immediately,” including “immediately before” or “immediately after” refers to a time period that is within several minutes, preferably with several seconds.

More particularly, the present invention relates generally to a method of producing a composite panel, the method comprising the steps of:
a) placing a veneer in a mold, said veneer having a face side and a backside, wherein the veneer is placed face side down;
b) dispensing an expandable foam onto the backside of the veneer in the mold; and
c) placing a cover over the expandable foam in the mold, wherein the cover is placed over the expandable foam prior to the foam expanding; and
d) allowing the foam to expand in the mold;
wherein expansion of the foam in the closed mold is restricted.

As described herein, the veneer is a decorative veneer, including, for example, porcelain, natural stone (including granite and marble), wood veneer, plastic laminate (e.g., Formica®), solid surface materials (e.g., Corian®) and similar materials, concrete, plastic, and any other similar materials which are capable of adhering to the expandable foam layer without the need for an adhesive. That is, an adhesive is not required in the present invention and the process described herein does not utilize an adhesive for joining the various materials that make up the composite panel. The veneer may have a thickness of less than about 10 mm, or less than about 6 mm, or less than about 3 mm.

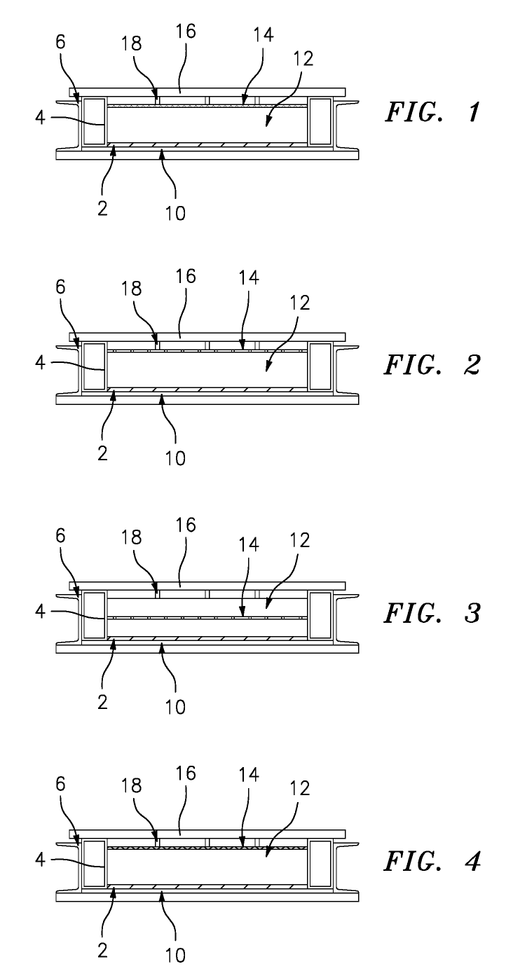

During the process described herein and as shown in FIGS. 1-7, a decorative veneer 2 is placed face side down into the mold cavity 4 of mold 6. As seen FIGS. 1-7, mold cavity 4 comprises sidewalls of a sufficient depth to contain the expandable foam 12 after it has expanded within the mold cavity 4 and a bottom plate 10 that is preferably machined to be flat and smooth.

If the mold 6 is constructed of a heat absorbing material, such as metal, the mold is heated to a temperature of at least about 80° F., more preferably to a temperature of between about 80 and about 120° F. to evaporate any moisture on the back of the veneer 2. The back side of the veneer 2 is then cleaned to remove any dust or debris from the surface that would prevent the expandable foam 12 from adhering to the back side of the veneer 2.

The expandable foam 12 is then mixed and then cast or otherwise placed onto the back side of the veneer 2 in the mold cavity 4. In a preferred embodiment, the foam 12 comprises an expandable urethane foam. Other similar expandable foams may also be used in the practice of the invention so long as the expandable foam 12 is capable of adhering to the veneer 2 without the need for an adhesive, is compatible with other materials used in the process, and is capable of achieving the desired density upon expansion within the mold 6. Finally, the use of certain types of expandable foams 12 may also influence whether a reinforcing backing layer 14 is required to prevent to foam layer 12 from bending or bowing upon curing. Thus, in some embodiments, especially with very thin veneers, a reinforcing backing layer 14 may be necessary to prevent bending or bowing of the composite veneer panel.

The cover 16 of the mold 6 is closed under pressure or locked in place and the foam expands 12 to fill the cavity 4 between the outer surfaces. The cover 16 comprises a vent 18 to allow air into the mold cavity 4 and cause the expandable foam 12 to expand within the mold cavity 4.

The expandable foam 12 is designed to expand to a density of at least 6 pounds/ft³ lbs or more, and in some instances, at least 10 pounds/ft³ or more, by restricting the expansion of the foam in the closed mold. As described herein, “density” refers to the weight per cubic foot of the expanded foam (12″×12″×12″).

Once the foam is cured, the cover 16 is lifted and the slab, which comprises the veneer 2, expanded foam 12 and optional backing layer 14 is removed from the mold.

As described herein, a backing layer 14 or other reinforcing material that provides a reinforcement of the expanded foam layer may be used in the construction of the composite panel. This material can be placed within the mold either (1) as a reinforcing layer on top of the cast foam layer, (2) as a reinforcing layer on top of the backside of the veneer prior to the expandable foam being cast into the mold; or (3) as reinforcing material disposed or dispersed in the expandable foam layer. Depending on the composition of the expandable foam layer and the type of decorative veneer, the composite panel may or may not contain a reinforcing layer or material.

Materials that create an internal reinforcement include, for example, chopped or continuous fibers that are dispersed within the expanded foam layer or a portion thereof. Other materials used to create reinforcing layers or membranes include, for example, continuous fiber mats or a mesh or bars or strips or a honeycomb, or a membrane or any other material that can be placed in the mold so that the material spans the entire or almost the entire length and width of the veneer panel and that the foam is capable of attaching to as it expands. In addition, wood, honeycomb, plywood, fabric, cementious, ceramic and porcelain boards and sheets, as well as other similar materials can also be used as a reinforcing layer.

In one embodiment, the composite panel does not contain any internal reinforcement or reinforcing backing layer.

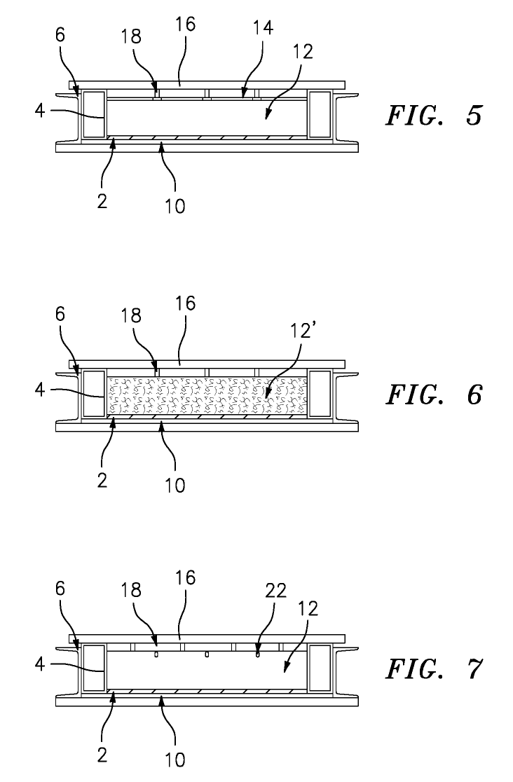

In another embodiment, the composite panel contains a reinforcing backing layer as shown, for example, in FIGS. 1, 2, 4 and 5. As shown in FIG. 1, the backing layer may comprise a flexible membrane. As shown in FIG. 2, the backing layer may comprise a woven mesh. As shown in FIG. 4, the backing layer may comprise a continuous filament mat. As shown in FIG. 5, the backing layer may comprise a rigid membrane.

In another embodiment, the composite panel contains an internal reinforcement layer as shown, for example, in FIG. 3. As shown in FIG. 3, the internal reinforcement layer may comprise a woven mesh.

In another embodiment, the expandable foam layer may contain reinforcing material as shown, for example in FIGS. 6 and 7. As shown in FIG. 6, the expandable foam layer may contain chopped fibers which are dispersed throughout the expandable foam layer. As shown in FIG. 7, a plurality of metal rods 22 may be disposed on top or within the expandable foam layer 12.

In another embodiment, the process described herein can be used to create a structurally insulated panel, which contains plywood instead of veneer. In another embodiment, the expandable foam layer can be sandwiched between two plies or veneers.

In another embodiment, the reinforcing layer disposed on the layer of expandable foam within the mold cavity or on the back side of the veneer so as to form a reinforcing layer with the expandable foam layer may comprise a mesh-reinforced membrane, such as a fiberglass mesh reinforced polymer membrane that comprises a mixture of finally graded sand and a water-based resin. The water-based resin must be capable of adhering to the urethane foam.

The water-based resin used in the membrane must be capable of adhering to the expandable urethane foam.

In one embodiment, the resin is a water-based polymer resin such as Vinnapis®, preferably Vinnapis® 5044N, which is based on vinyl acetate and ethylene and exhibits good tensile adhesion strength. Other vinyl acetate polymers may also be used in the practice of the invention, including, for example, vinyl acetate homopolymers and vinyl acetate copolymers comprising in polymerized form vinyl acetate and ethylene and optional ethylenically unsaturated comonomers.

Typically, the vinyl acetate copolymer comprises 0 to 25% by weight of optional comonomers. Preferably, the vinyl acetate copolymer comprises in polymerized form 70 to 95% by weight of vinyl acetate; 5 to 30% by weight of ethylene; and 0 to 25% by weight of one or more optional comonomers, based on the total weight of the polymer.

The ethylenically unsaturated comonomers that may optionally be copolymerized to form the vinyl acetate copolymer include, for example, vinyl esters other than vinyl acetate such as vinyl propionate, vinyl butyrate, vinyl benzoate, vinyl 2-ethylhexanoate, vinyl stearate and the vinyl esters of versatic acid; alkyl vinyl ethers, typically C1-C8 alkyl vinyl ethers such as methyl vinyl ether, ethyl vinyl ether, isopropyl vinyl ether, n-propyl vinyl ether, tert-butyl vinyl ether, n-butyl vinyl ether, and isobutyl vinyl ether; amides and C1-C8 alkyl esters of unsaturated carboxylic acids, typically of acrylic acid and methacrylic acid such as methyl methacrylate, butyl acrylate, and 2-ethylhexyl acrylate.

Typically, the vinyl acetate polymer has a glass transition temperature Tg of less than about 15° C., preferably less than about 12° C., more preferably less than about 10° C., and most preferably less than about 7° C.

The resin/sand mixture preferably comprises at least about 45% by weight sand, more preferably, at least about 60% by weight sand, more preferably, at least about 80% by weight sand, most preferably at least about 85% by weight sand.

Furthermore, the resin/sand mixture is preferably impregnated with reinforcing fibers, including, for example, glass, fiberglass or wood fibers, and said fibers may be chopped, or in the form of a continuous fiber mat or mesh.

The mesh-reinforced membrane may be produced by first mixing the sand and resin together and then casting the resin/sand mixture onto smooth surface.

In one embodiment, the resin/sand mixture is prepared by first mixing a suitable polymer powder such as Vinnapis® 5044N, available from Wacker Chemie AG, with water. The ratio of water to polymer powder is generally with the range of about 30%/70% by weight to about 70%/30% by weight water/polymer, more preferably about 50%/50% by weight to about 60%/40% by weight water/polymer. A second mixture is then prepared comprising a mixture of granular sand (about 90 to about 130 mesh, more preferably about 110 to about 125 mesh) with silica flour (at least about 300 mesh, more preferably about 325 mesh). This second mixture preferably comprises at least about 60% by weight granular sand, more preferably at least about 70% by weight granular sand, and most preferably, at least about 80% by weight granular sand, with the remainder being silica flour. Other similar sand/flour combinations are also usable in the practice of the invention.

Thereafter, the water/polymer mixture is mixed with the sand mixture and is cast onto a smooth surface.

Optionally, but preferably, the smooth surface may comprise a mold release layer, such as polyvinyl chloride (PVC), silicone rubber, polished granite, glass. The casting step can be performed by various methods including, for example, by spraying, pouring, dispensing, or other such methods known in the art to provide a uniform layer of material.

The final composition of the mesh-reinforced membrane comprises a mixture of water, polymer and sand. In a preferred embodiment, the polymer must be more than 7 percent by weight in final composition with the sand mixture, more preferably, the polymer is in the range of about 10 to about 12 percent by weight in the final composition with the sand mixture.

An additive may also be added to keep polymer powder in suspension. For example, one suitable additive is mineral filler.

Depending on the casting method, the membrane mixture may be leveled. For example, if the membrane mixture is poured, vibrations or a trowel may be used to level the mixture.

Thereafter, reinforcing material is added to the membrane mixture to create the mesh reinforced membrane. As described herein, this reinforcing material may comprise, for example, mat, fibers, or a continuous fiber mat.

The present invention also relates generally to an impact resistant, decorative, lightweight structural veneer composite panel produced by the method described herein. This composite panel preferably comprises:

a) a decorative veneer sheet;

b) an expanded foam layer, wherein the expanded foam layer has a density of at least about 6 pounds/ft³;

and

c) optionally, a reinforcing membrane,

wherein an adhesive is not used to join the decorative veneer sheet with the expanded foam layer.

### EXAMPLE 1

A composite panel was produced according to the following steps:
a. A decorative veneer sheet (6 mm porcelain) was situated face side down in a bottom of a mold cavity;
b. The back surface of the veneer was cleaned to removed dust and debris and the mold was heated to a temperature of about 110° F. to remove any residual moisture on from the surface;
c. An expandable liquid urethane resin was placed onto the back side of the veneer that was capable of expanding into an expanded foam exhibiting a density of at least 6 pounds/ft³ within a closed mold;
d. A reinforcing material (mesh reinforced membrane) was placed on top of the expandable liquid urethane resin; and
e. The open mold was covered with a lid to restrict expansion of the foam and the lid was locked into place;
f. The expandable foam was allowed to expand and cure within the mold cavity; and
g. Once the mold was expanded and cured, the resulting composite panel was removed from the mold.

The resulting composite panel was subjected to a pressure test in which a 10-inch overhang of the panel was subjected to pressure and was able to withstand more than 500 pounds of pressure without breakage, which is the same strength exhibited by a standard 1¼ inch granite slab.

What is claimed is:

1. A method of producing a composite panel, the method comprising the steps of:
a) placing a veneer in a mold, said veneer having a face side and a backside, wherein the veneer is placed face side down;
b) dispensing an expandable foam onto the backside of the veneer in the mold; and
c) placing a cover over the expandable foam in the mold, wherein the cover is placed over the expandable foam prior to the foam expanding; and
d) allowing the foam to expand in the mold;
wherein expansion of the foam in the closed mold is restricted.

2. The method according to claim 1, further comprising a step of disposing a backing layer in the mold. wherein a backing layer is disposed over the expandable foam.

3. The method according to claim 2, wherein the backing layer is selected from the group consisting of engineered wood, fiberglass sheets, fiberglass mats, fabric sheets, honeycombs, membranes, chopped fiber mats, continuous fiber mats, reinforcing skins, and cementious, ceramic and porcelain boards and sheets.

4. The method according to claim 1, wherein the backing layer is dispose over the backside of the veneer.

5. The method according to claim 1, wherein the veneer is a material selected from the group consisting of porcelain, natural stone, granite, marble, wood, plastic laminate, solid surface materials, and concrete.

6. The method according to claim 1, further comprising the step of heating the mold to a temperature of at least 80° F. to evaporate any moisture on the backside of the veneer prior to step b).

7. The method according to claim 1, further comprising the step of cleaning the backside of the veneer prior to step b) to remove any dirt or dust from the surface.

8. The method according to claim 1, wherein the step of allowing the foam to expand into the mold includes venting the cover to allow air into the mold cavity, wherein the expandable foam expands within the mold cavity.

9. The method according to claim 1, wherein the veneer has a thickness of less than about 10 mm.

10. The method according to claim 9, wherein the veneer has a thickness of less than about 6 mm.

11. The method according to claim 10, wherein the veneer has a thickness of less than about 3 mm.

12. The method according to claim 1, further comprising the step of removing the composite panel from the mold.

13. The method according to claim 1, wherein an adhesive is not used to join the veneer to the expanded foam layer.

14. An impact resistant, decorative, lightweight structural veneer composite panel comprising:
a) a decorative veneer sheet;
b) an expanded foam layer, wherein the expanded foam layer has a density of at least about 6 pounds/ft³;
and
c) optionally, a reinforcing membrane,
wherein an adhesive is not used to join the decorative veneer sheet with the expanded foam layer.

15. The veneer composite panel according to claim 14, wherein the decorative veneer sheet is selected from the group consisting of porcelain, natural stone, granite, marble, wood, plastic laminate, solid surface materials, and concrete.
